(19) United States
(12) Patent Application Publication
(10) Pub. No.: US 2017/0219187 A1
(43) Pub. Date: Aug. 3, 2017

(54) LED lighting device

(71) Applicant: THE MAD PIXEL FACTORY, S.L., MADRID (ES)

(72) Inventor: Fernando García Lema, MADRID (ES)

(21) Appl. No.: 15/501,143

(22) PCT Filed: Aug. 5, 2015
(86) PCT No.: PCT/ES2015/070613

§ 371 Date: Feb. 1, 2017

(30) Foreign Application Priority Data
Aug. 5, 2014 (ES) P201431196

(51) Int. Cl. F21V 17/10; F21L 2/00; F21V 29/70; F21V 17/04; F21V 19/00; F21V 21/06; F21L 14/00; F21V 14/00

(52) U.S. Cl. CPC F21V 17/105; F21L 14/00; F21L 2/00; F21V 14/006; F21V 17/04; F21V 19/003; F21V 21/06; F21V 29/70

(57) ABSTRACT

The invention relates to a high-power LED lighting device which is portable and ultra-light, comprising: a light (2) comprising a carbon board (21) to the outer face of which at least one high-power LED (23) plate (22) is attached; a tripod (3) formed from carbon to which the light can be coupled; and a power supply source (4) that can be connected to the light (2) and is housed in a carbon box.

### OBJECT OF THE INVENTION

The present invention generally pertains to the field of lighting, for example for stage shows, movie recording, high resolution image acquisition, etc.

The object of the present invention is a new high-power LED lighting device, which is portable and ultra-light.

### BACKGROUND OF THE INVENTION

In order to acquire high resolution images of works of art, such as pictures or similar objects, it is necessary to have a powerful and precise illumination means to clearly distinguish the color, brightness, texture, and other surface characteristics of the painting in question. An inadequate illumination can cause the acquisition of shady or inaccurate images, which negatively influences the quality of the final composite image. Also in other areas such as film recording, theater, and other stage shows of various types, there are very demanding lighting needs to avoid the loss of quality of the recording or of the show in question.

To solve the problem of lighting in these and other contexts, there are currently devices formed by a lighting means mounted on a tripod that allows for orienting it to illuminate the desired object or area. The lighting medium is usually of the fluorescent type. By way of example, there may be mentioned lighting devices marketed by the company Kino Flo Lighting Systems®, such as for example the one described in U.S. Pat. No. 5,132,885 or those shown on the following website:

http://www.kinoflo.com/Products%20Button/Kits/4Bank%20&%20DMX/ 4Bank_&_DMX.html

However, while these lighting devices adequately fulfill the lighting function for which they were conceived, they are difficult to transport and handle because they are often too heavy (often exceeding 30 kg). They are also very bulky, which forces to transport them dismantled in suitcases or large containers.

### DESCRIPTION OF THE INVENTION

The present invention solves the above problems thanks to a new design based on LED devices and materials used in aeronautics, much lighter and providing superior light output per unit weight, combined with the use of carbon instead of aluminum as long as it has been possible.

The final result is, for example, in the particular embodiment described later herein, a very lightweight, compact and lightweight lighting device whose approximate final weight is 6 kg (note that Kino Flo Lighting Systems devices weigh up to 34 kg, weighing 9.5 kg the lightest). In addition, all the elements constituting the device of the invention fit in an aluminum suitcase of approximate dimensions of 45×33×15 cm (note that the largest dimension of the systems marketed by Kino Flo Lighting Systems can exceed 140 cm, with 70 cm the smaller of such major dimensions).

The LED lighting device of the present invention essentially comprises the following parts: a light, a tripod to which the light is attached, and a power supply for the light. Each of these elements is described in more detail below.

a) Light
The light consists of a carbon plate whose outer face is attached to at least one high-power LED plate or “LED PCB board”. As will be seen hereinafter, in a particular embodiment of the invention the light comprises a carbon plate having two plates of 28 LEDs each. However, the present invention also encompasses other combinations, such as for example lights formed by a carbon plate to which one, two, or more LED plates are attached.
In this context, it is understood that the “outer face” or “front face” of both the carbon plate and the LED plate is that which, in use, will be facing the object being illuminated, whereas the “inner face” or “back face” is that which, in use, is concealed relative to said object.
In a preferred embodiment of the invention, the at least one LED plate comprises 28 high-power LEDs, i.e. with an approximate power of 1 W each of them. In addition, LEDs with a high beam angle are preferably used, for example equal to or greater than 140°.
In a preferred embodiment, the at least one LED plate is attached to the plate such that there is a space between both plates for air circulation for the dissipation of the generated heat. In addition, the inner face of the at least one LED plate has a heat dissipation structure made of aluminum.
Additionally, the plate preferably comprises rods protruding from its outer face and provided with a magnet to allow the coupling of color filters. It is thus possible to couple a color filter in a quick and simple way in case it is necessary to modify the characteristics of the light emitted by the LEDs to, for example, provide more warmth to the light provided by the light.
With regard to attaching the light to the tripod, in a preferred embodiment of the invention, the plate comprises slots through which a hand-tightening Velcro strip runs for coupling the light to the tripod. The strip passes through the slots “embracing” the part of the plate between the holes and attaches to the tripod. In addition, to prevent the plate from sliding in its coupling to the tripod, the inner face thereof comprises an anti-slip zone that allows the coupling of the light to the tripod to be strong.

b) Tripod

The tripod serves for attaching the light so that it is at a height adequate to illuminate the object whose images are to be acquired. In order to minimize its weight as much as possible, the tripod of this invention is made of carbon instead of aluminum which is conventionally used.

c) Power Supply
The power supply can be connected to the light to supply the corresponding supply voltage. In addition, to minimize its weight, it is housed in a carbon box that replaces the usual metal boxes.
According to a preferred embodiment of the invention, a regulated power supply is used which allows controlling the voltage applied to the at least one LED plate.

### BRIEF DESCRIPTION OF THE FIGURES

FIG. 1 shows a perspective rear view of a particular example LED lighting device of the present invention.

FIG. 2 shows a front perspective view of the LED lighting device of FIG. 1.

FIGS. 3a and 3b show respectively a plan view and an elevation view of a light provided with two LED plates.

FIG. 4 shows a perspective view of a power supply.

### PREFERRED EMBODIMENT OF THE INVENTION

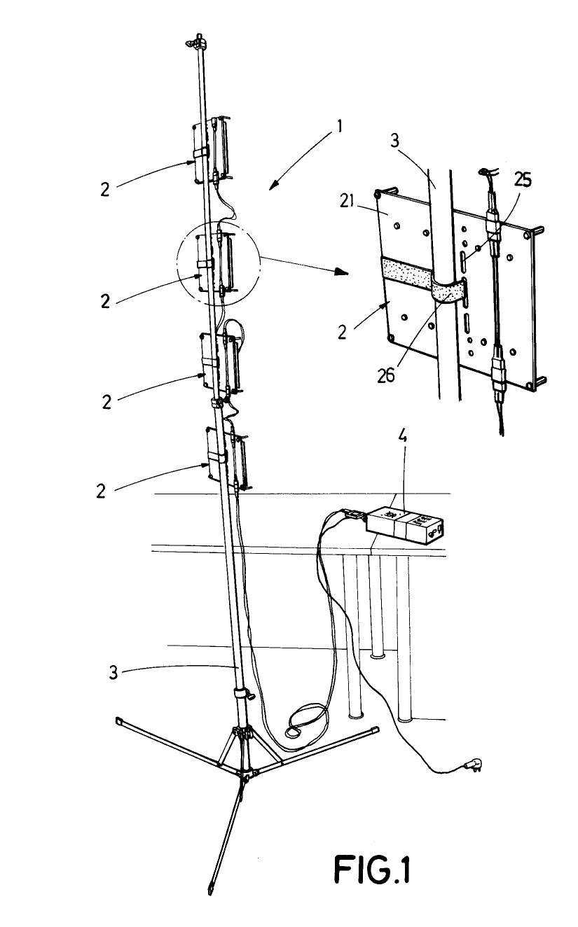

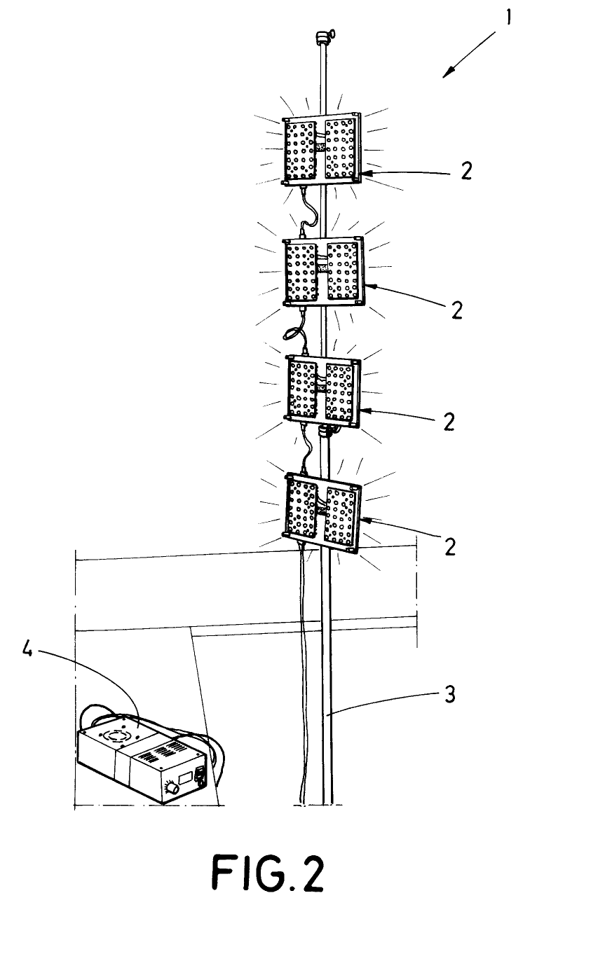

A particular example of LED lighting device (1) according to the present invention will be now described with reference to the accompanying figures. As shown in FIGS. 1 and 2, the device (1) basically comprises one or more lights (2), in this case four, attached to a tripod (3) and powered by a power supply source (4).

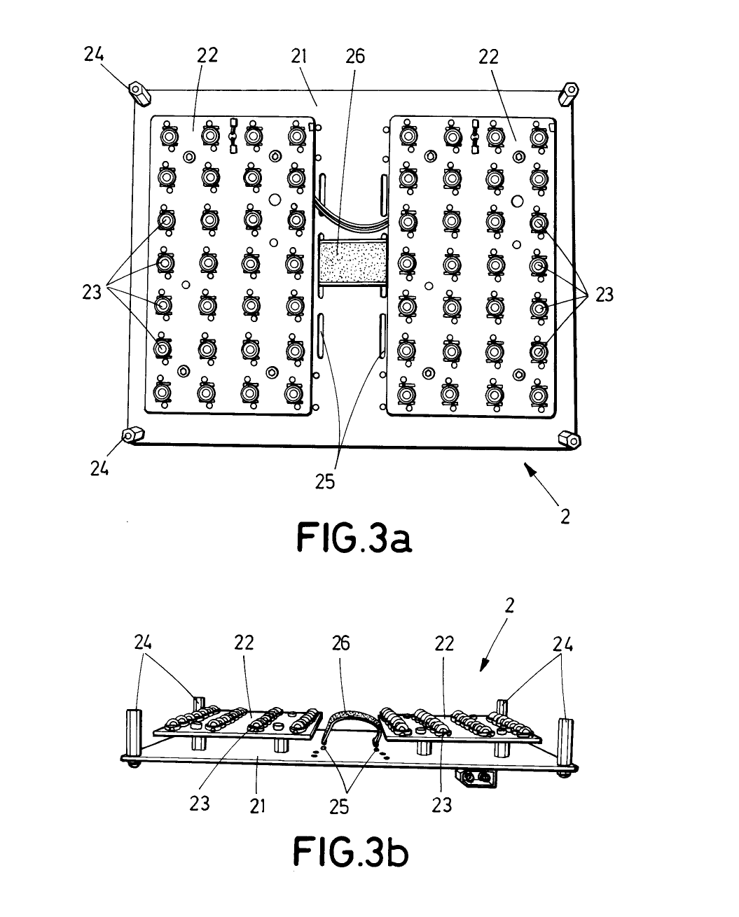

FIGS. 3a and 3b show an example of light (2) in more detail so as to appreciate the different parts that compose it. Specifically, the light (2) in FIG. 2 is formed by a pure twill matte carbon plate (21) to which two plates (22) each having 28 LEDs (23), are attached. The attaching between the plates (22) and the plate (21) is carried out by means of 4 nylon supports and anti-locking nuts, leaving a space between the plates (22) and the plate (21) to allow the passage of air. In addition, each plate (22) has on its rear face an aluminum structure designed for the dissipation of the heat emitted by the LEDs (23) during their operation. LEDs (23) are 1 W of power. The total power of each plate (22) will then be 28 w, and the total power of each light (2) will be 56 w. The LED diodes (23) are chosen with a high beam angle, for example 140°. Each plate (22) has on its rear face a small power connector (not shown) to allow a rapid replacement if necessary.

The lights (2) also have four nylon rods (24) attached to the corners of the carbon board (21) by anti-locking nuts and having at their free end neodymium magnets inserted under pressure in the metric gap. Thereby, color filters (not shown) can be affixed to the lights (2) by means of small staples and/or magnets at their ends.

Each light (2) has a first female XT60 connector attached to the back face of the plate (21) for connection to the power supply source (4). Suitable electrical conductors distribute the received current in parallel between the two LED (23) plates (23) and exits again through a second female XT60 connector also attached to the rear face of the plate (21).

The tripod (3), which is formed by carbon tubes replacing conventional aluminum tubes, comprises a base formed by three tubes supporting a vertical mast to which the lights (2) are attached. For attaching the lights (2) to the mast of the tripod (3), the plate (21) has a series of through slots (25) in its central area through which a hand-tightening Velcro strip (26) passes. This Velcro strip (26) is wound around the mast of tripod (2) and tightened tightly. To prevent the lights (2) from sliding down by gravity, the center of the rear face of the plate (21) has an anti-slip zone (not shown) which, when pressed against the mast of tripod (3), prevents the sliding of the light (2).

In short, this design allows obtaining small compact lights (2) with very small dimensions (approximately 20×15×25 cm). At the same time, they are light and robust, since the carbon is lighter than the aluminum and more resistant than the steel to equal dimensions. Its approximate weight is 270 grams per light (2). In terms of light output, they can output up to 1600 Lux at 1 meter distance (5040 Lumens).

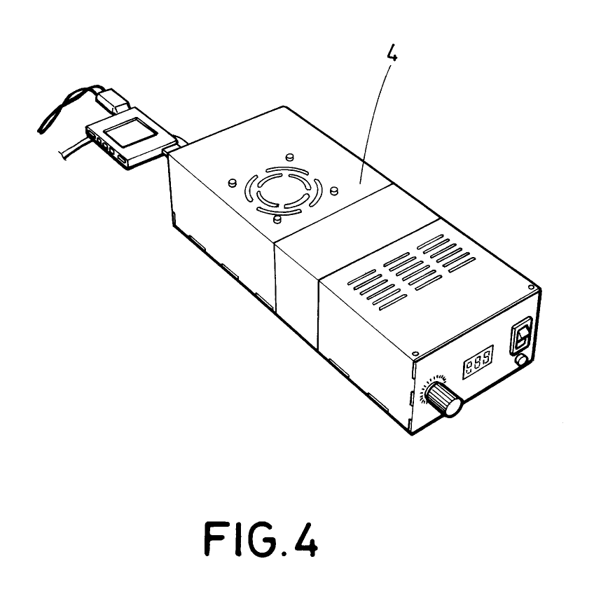

In relation to the power supply source (4), shown in FIG. 4, it is a 240 W regulated indoor power supply source housed inside a 2-mm pure twill carbon fiber box. As shown in FIG. 4, the power supply source (4) has a power switch, a status LED, a wheel for controlling the supplied current, and a display showing the current supplied at each moment. A standard AC plug with ground protection is used for connection to the mains and two female XT60 connectors for the current output to the lights (2).

The approximate dimensions of the power supply source (4) are 20×11×6 cm, and its weight is approximately 1148 grams. It is dimensioned to supply a power for up to 4 lights (2) as described previously, connected in parallel. Alternatively, it would be possible to accommodate in the carbon fiber box a power supply source (4) with a power of 480 w, which would allow powering 8 of such lights (2) with a single power supply source (4).

For the interconnection wiring of the lights (2), 18AWG silicone cable has been used, especially for its flexibility and high resistance, the ends of which have male XT60 connectors to avoid possible mistakes when connecting them to the lights (2) and the power supply source (4).

In short, the entire device (1) is highly maneuverable, compact and lightweight. Two devices (1) such as those shown in the accompanying figures comprise, in total, 8 lights (2), two tripods (3), 2 power supplies (4), several filters and 40 meters of cable. All these elements fit in an aluminum case of 45×33×15 cm, with a final weight of approximately 6 kg. These two devices (1) are capable of generating a light intensity of 12800 lux at 1 meter distance.

1. An LED lighting device (1), comprising:
a light (2) including a carbon board (21) having an outer face;
at least one high-power LED (23) plate (22) attached to the outer face of the carbon board (21);
a tripod (3) formed from carbon to which the light (2) can be coupled; and
a power supply source (4) that can be connected to the light (2) and that is housed in a carbon box.

2. An LED lighting device (1) according to claim 1, wherein the at least one LED (23) plate (22) comprises twenty-eight LEDs (23).

3. An LED lighting device (1) according to claim 1, wherein the at least one LED (23) plate (22) comprises a plurality of LEDs (23), and wherein the LEDs (23) have a beam angle equal to or greater than 140°.

4. An LED lighting device (1) according to claim 1, wherein the at least one LED (23) plate (22) is attached to the carbon board (21) such that there is a space between the at least one LED (23) plate (22) and the carbon board (21) for air circulation.

5. An LED lighting device (1) according to claim 1, wherein an inner face of the at least one LED (23) plate (22) has a heat dissipation structure made of aluminum.

6. An LED lighting device (1) according to claim 1, wherein the carbon board (21) comprises rods (24) protruding from its outer face and provided with a magnet to enable coupling of color filters.

7. An LED lighting device (1) according to claim 1, wherein the carbon board (21) comprises slots (25) through which a hand-tightening Velcro strip (26) is provided for coupling the light (2) to the tripod (3).

8. An LED lighting device (1) according to claim 1, wherein an inner face of the carbon board (21) comprises an anti-slip zone configured to strengthen coupling of the light (2) to the tripod (3).

9. An LED lighting device (1) according to claim 1, wherein the power supply source (4) is adjustable to enable controlling a voltage applied to the at least one LED (23) plate (22).

10. An LED lighting device (1) according to claim 1, wherein the light (2) comprises a first light (2), the LED lighting device (1) further comprising a second light (2), a third light (2), and a fourth light (2).

11. An LED lighting device (1) according to claim 10, wherein each of the first light (2), the second light (2), the third light (2), and the fourth light (2) includes a respective said carbon board (21) attached to a respective said two LED (23) plates.
